(19) United States
(12) Patent Application Publication
(10) Pub. No.: US 2026/0152302 A1
(43) Pub. Date: Jun. 4, 2026

(54) METHOD OF DOCKING DRONE AND DRONE SYSTEM

(71) Applicant: Metal Industries Research & Development Centre, Kaohsiung (TW)

(72) Inventors: Kuang-Shine Yang, Tainan City (TW); Chao Chieh Hsu, Kaohsiung City (TW); Ping-Hua Su, Kaohsiung City (TW); Tsung-Yi Lan, Kaohsiung City (TW); Wei-Lun Hsu, Kaohsiung City (TW); Hung-Chun Shen, Kaohsiung City (TW)

(73) Assignee: Metal Industries Research & Development Centre, Kaohsiung (TW)

(21) Appl. No.: 18/966,080

(22) Filed: Dec. 2, 2024

(51) Int. Cl. B64U 70/90; B64U 70/50; B64U 80/20

(52) U.S. Cl. CPC B64U 70/90; B64U 70/50; B64U 80/20

(57) ABSTRACT

A method of docking a drone and a drone system are provided. The method includes: disposing a first charging terminal on a docking plate; determining whether a drone is landed on the docking plate; and in response to the drone being landed on the docking plate, driving a pusher rod to push the drone to a default position on the docking plate.

### BACKGROUND

### Technical Field

The disclosure relates to a drone technology, and particularly relates to a method of docking a drone and a drone system.

### Description of Related Art

Drone systems have been widely applied in various fields. For example, drones may be configured to patrol different fields automatically to achieve the purpose of automated monitoring. Generally, when a drone needs to be charged, the drone needs to return to a location of a ground control station (GCS) for charging. When a distance between the field monitored by the drone and the GCS is relatively far, executing a task of the drone may waste a lot of energy and time. Accordingly, how to improve the working efficiency of drones in far fields is one of the important issues in this field.

### SUMMARY

The disclosure provides a method of docking a drone and a drone system, which can provide a more flexible charging manner for the drone.

A drone system of the disclosure includes a drone docking device. The drone docking device includes a docking plate, a first pusher rod, a first actuator, and a controller. The docking plate is configured with a first charging terminal. The first actuator is configured to move the first pusher rod. The controller is coupled to the first charging terminal and the first actuator. The controller determines whether the drone is landed on the docking plate. In response to the drone being landed on the docking plate, the controller drives the first pusher rod by the first actuator to push the drone to a default position on the docking plate.

In an embodiment of the disclosure, the aforementioned drone docking device further includes a second pusher rod. The first actuator is configured to move the second pusher rod. In response to the drone being landed on the docking plate, the controller drives the first pusher rod to move in a first direction by the first actuator and controls the second pusher rod to move in a second direction, where the second direction is opposite to the first direction.

In an embodiment of the disclosure, the aforementioned drone docking device further includes a threaded rod. The threaded rod is driven by the first actuator, where one end of the threaded rod has a left-handed thread, and the other end of the threaded rod has a right-handed thread. The first pusher rod includes a first nut engaging with the left-handed thread, and the second pusher rod includes a second nut engaging with the right-handed thread.

In an embodiment of the disclosure, the aforementioned controller determines whether the drone on the docking plate is about to take off. In response to the drone being about to take off, the controller drives the first pusher rod by the first actuator to make the first pusher rod move away from the drone.

In an embodiment of the disclosure, the aforementioned drone system further includes the drone. The drone includes a second charging terminal. After the drone is pushed to the default position, the second charging terminal contacts the first charging terminal, and the controller charges the drone through the second charging terminal.

In an embodiment of the disclosure, the aforementioned second charging terminal is fixed to a landing gear of the drone by a spring.

In an embodiment of the disclosure, the aforementioned drone system further includes a cabinet. The cabinet includes a flip lid and a second actuator coupled to the controller, where the drone docking device is disposed inside the cabinet. The controller opens the flip lid by the second actuator to expose the docking plate. The controller closes the flip lid by the second actuator to cover the docking plate.

In an embodiment of the disclosure, a storage space is formed between the aforementioned docking plate and a bottom of the cabinet, and the docking plate has an opening exposing the storage space.

In an embodiment of the disclosure, the aforementioned storage space is injected with a cleaning solution. When the drone is at the default position, an object suspended on the drone enters the storage space through the opening to be immersed in the cleaning solution.

In an embodiment of the disclosure, the aforementioned drone system further includes the drone. The drone is landed at a first position, and is landed at a second position after taking off from the first position. In response to the first position and the second position belonging to different areas, the drone is docked on the drone docking device before proceeding to the second position.

In an embodiment of the disclosure, the aforementioned drone docking device further includes a torque sensor. The torque sensor is coupled to the controller, wherein the torque sensor is configured to measure torque of the first actuator, where the controller determines whether the torque is greater than a threshold. In response to the torque being greater than the threshold, the controller drives the first pusher rod to move the first pusher rod away from the drone on the docking plate.

A method of docking a drone according to the disclosure includes: disposing a first charging terminal on a docking plate; determining whether the drone is landed on the docking plate; and in response to the drone being landed on the docking plate, driving a first pusher rod to push the drone to a default position on the docking plate.

Based on the above, the drone system of the disclosure may provide a drone docking device with a smaller volume and convenient setup for the drone to charge, clean, or disinfect.

### BRIEF DESCRIPTION OF THE DRAWINGS

FIG. 1 illustrates a schematic diagram of a drone system according to an embodiment of the disclosure.

FIG. 2 illustrates a schematic diagram of an opening process of a cabinet according to an embodiment of the disclosure.

FIG. 3 illustrates a schematic diagram of a docking plate according to an embodiment of the disclosure.

FIG. 4 illustrates a schematic diagram of accessories of a docking plate according to an embodiment of the disclosure.

FIG. 5 illustrates a schematic diagram of a pusher rod stopper and a charging mechanism according to an embodiment of the disclosure.

FIG. 6 illustrates a schematic diagram of a charging mechanism according to an embodiment of the disclosure.

FIG. 7 illustrates a flowchart of opening a cabinet according to an embodiment of the disclosure.

FIG. 8 illustrates a flowchart of takeoff of a drone according to an embodiment of the disclosure.

FIG. 9 illustrates a flowchart of landing of a drone according to an embodiment of the disclosure.

FIG. 10 illustrates a flowchart of a method of docking a drone according to an embodiment of the disclosure.

### DESCRIPTION OF THE EMBODIMENTS

To make the content of the disclosure comprehensible, embodiments are specifically given below as examples in which the disclosure may be actually implemented. In addition, wherever possible, the same reference numerals are used in the drawings and embodiments to refer to the same or similar elements/components/steps.

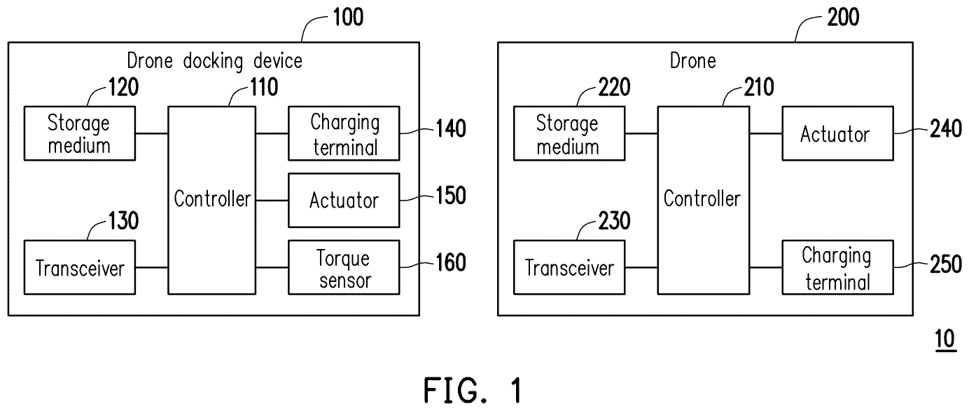

FIG. 1 illustrates a schematic diagram of a drone system 10 according to an embodiment of the disclosure. The drone system 10 may include a drone docking device 100. In an embodiment, the drone system 10 may further include a drone 200. The drone docking device 100 and the drone 200 may be communicatively connected to each other.

The drone docking device 100 may include a controller 110, a storage medium 120, a transceiver 130, one or multiple charging terminals 140, one or multiple actuators 150, and one or multiple torque sensors 160.

The controller 110 may be, for example, a central processing unit (CPU), a programmable micro control unit (MCU) for a common purpose or a specific purpose, a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), other similar elements, or a combination of the aforementioned elements. The controller 110 may be coupled to the storage medium 120, the transceiver 130, the charging terminal 140, the actuator 150, or the torque sensor 160, and access and execute multiple modules and various applications stored in the storage medium 120.

The storage medium 120 may be, for example, any type of a fixed or removable random access memory (RAM), read-only memory (ROM), flash memory, hard disk drive (HDD), solid state drive (SSD), similar elements, or a combination of the aforementioned elements, configured to store multiple modules or various applications which may be executed by the controller 110.

The transceiver 130 transmits or receives signals in a wireless or wired manner. The transceiver 130 may further perform operations such as low noise amplification, impedance matching, frequency mixing, up or down frequency conversion, filtering, or amplification. The controller 110 may be communicatively connected to the drone 200 or a GCS through the transceiver 130.

The charging terminal 140 may include metal plates. When a charging terminal 250 of the drone 200 contact the charging terminal 140, the controller 110 may charge the drone 200 through the charging terminal 140 and the charging terminal 250.

The actuator 150 may include devices such as motors or threaded rods. The controller 110 may drive an object to move by the actuator 150.

The torque sensor 160 may be configured to detect torque. For example, the torque sensor 160 may be configured to measure the torque generated by the actuator 150 when moving the object.

The drone 200 may include a controller 210, a storage medium 220, a transceiver 230, an actuator 240, and one or multiple charging terminals 250.

The controller 210 may be, for example, a CPU, a programmable MCU for a common purpose or a specific purpose, a microprocessor, a DSP, a programmable controller, an ASIC, a GPU, an ISP, an IPU, an ALU, a CPLD, a FPGA, other similar elements, or a combination of the aforementioned elements. The controller 210 may be coupled to the storage medium 220, the transceiver 230, the actuator 240, and the charging terminal 250, and may access and execute multiple modules and various applications stored in the storage medium 220.

The storage medium 220 may be, for example, any type of a fixed or removable RAM, ROM, flash memory, HDD, SSD, similar elements, or a combination of the aforementioned elements, configured to store multiple modules or various applications which may be executed by the controller 210.

The transceiver 230 transmits or receives signals in a wireless or wired manner. The transceiver 230 may further perform operations such as low noise amplification, impedance matching, frequency mixing, up or down frequency conversion, filtering, or amplification. The controller 210 may be communicatively connected to the drone docking device 100 or the GCS through the transceiver 230.

The actuator 240 may include motors, for example. The controller 210 may drive the drone 200 to take flight by the actuator 240.

The charging terminal 250 may include metal plates. When the charging terminal 250 of the drone 200 contact the charging terminal 140, the controller 110 may charge the drone 200 through the charging terminals 140 and 250.

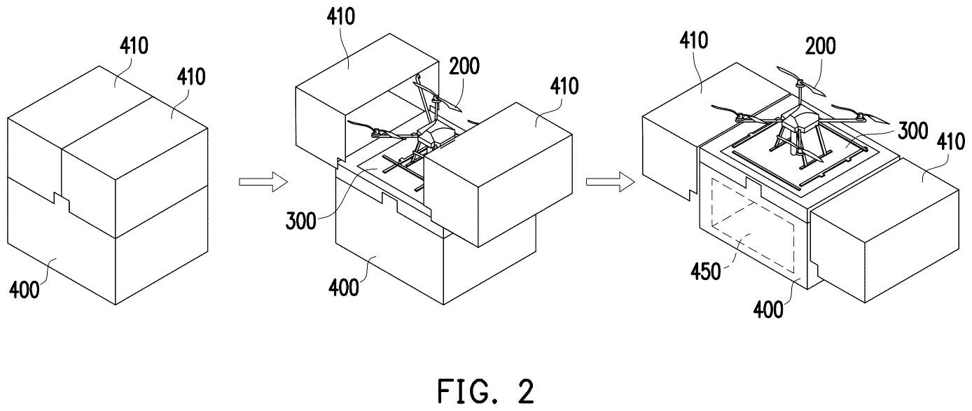

The drone system 10 may further include a cabinet 400, and the drone docking device 100 may further include a docking plate 300. FIG. 2 illustrates a schematic diagram of an opening process of the cabinet 400 according to an embodiment of the disclosure. Various elements of the drone docking device 100 may be placed inside the cabinet 400. The cabinet 400 may include a flip lid 410 and an actuator (not shown in the figure) coupled to the controller 110. The controller 110 may open the flip lid 410 by the actuator to expose the docking plate 300, as shown in FIG. 2. In another aspect, the controller 110 may close the flip lid 410 by the actuator to cover the docking plate 300.

The controller 110 may receive a signaling from the drone 200 or the GCS by the transceiver 130 to determine whether the drone 200 is about to take off from the docking plate 300 or land on the docking plate 300 according to the signaling. If the drone 200 is about to take off from the docking plate 300 or land on the docking plate 300, the controller 110 may open the flip lid 410 of the cabinet 400. In another aspect, if the drone 200 docked on the docking plate 300 is not about to take off or the drone 200 executing a task is not about to land on the docking plate 300, the controller 110 may close the flip lid 410 of the cabinet 400.

A storage space 450 may be formed between the docking plate 300 and a bottom of the cabinet 400. The storage space 450 may be injected with a cleaning solution configured to clean or disinfect the object suspended on the drone 200. The cleaning solution may include, but is not limited to, sodium hypochlorite (NaOCL) disinfectant water with 6% effective chlorine.

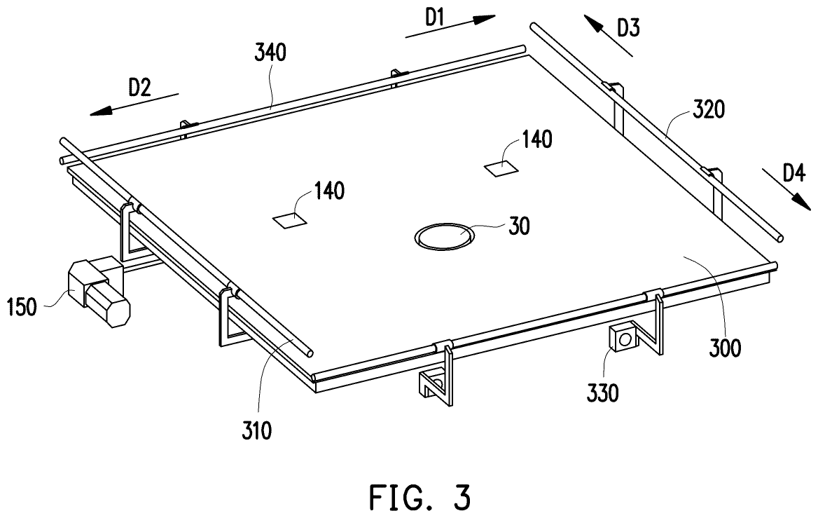

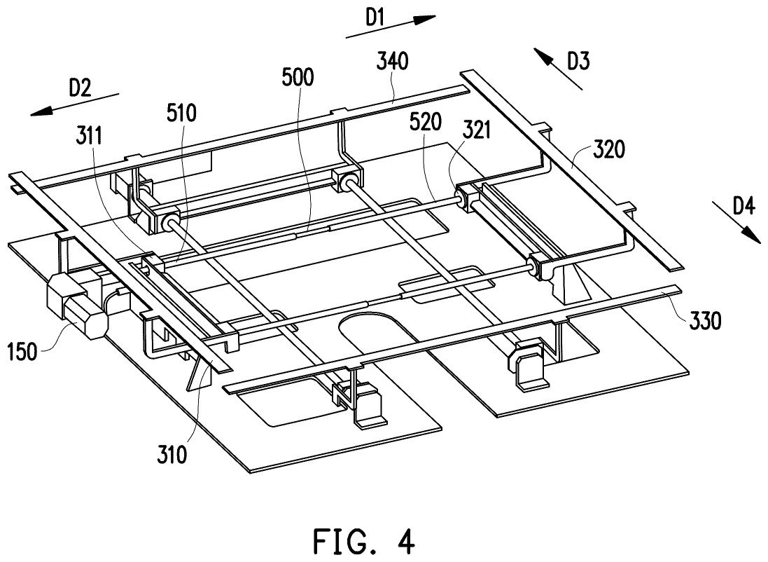

FIG. 3 illustrates a schematic diagram of the docking plate 300 according to an embodiment of the disclosure. FIG. 4 illustrates a schematic diagram of accessories of the docking plate 300 according to an embodiment of the disclosure. The drone docking device 100 may further include one or multiple pusher rods, such as pusher rods 310, 320, 330, and 340. The actuator 150 may be configured to move the pusher rods. One or multiple charging terminals 140 are disposed on a surface of the docking plate 300. The surface of the docking plate 300 has an opening 30 exposing the storage space 450. When the drone 200 is docked at a default position on the docking plate 300, the charging terminal 250 of the drone 200 may contact the charging terminal 140 of the drone docking device 100, and the object suspended on the drone 200 may enter the storage space 450 through the opening 30 to be immersed in the cleaning solution. When the charging terminal 250 contact the charging terminal 140, the controller 110 may charge the drone 200 through the charging terminals 140 and 250.

In an embodiment, assume that the drone 200 is landed at a first position and is about to proceed to a second position for landing. If the first position and the second position belong to different areas, the drone 200 may be docked at the drone docking device 100 for cleaning and disinfection before proceeding to the second position. For example, suppose that the task executed by the drone 200 includes sampling for different fish ponds. A sampler may be suspended on the drone 200. To avoid cross-contamination of bacteria between different fish ponds, the drone 200 must dock on the docking plate 300 to disinfect the sampler after completing sampling of one fish pond. The sampler may enter the storage space 450 through the opening 30 to be immersed in the cleaning solution. Only after the disinfection is completed may the drone 200 sample another fish pond by the sampler.

When being landed on the docking plate 300, the drone 200 may not be accurately landed at the default position on the docking plate 300 to make the charging terminal 250 contact the charging terminal 140. Accordingly, the drone 200 may not be able to be charged or the charging efficiency may be reduced. To make the drone 200 accurately dock at the default position on the docking plate 300, after the drone 200 is landed on the docking plate 300, the controller 110 may drive the pusher rods (for example, the pusher rods 310, 320, 330, or 340) by the actuator 150 to push the drone 200 to the default position on the docking plate 300 by the

Specifically, after the drone 200 is landed on the docking plate 300, the controller 110 may drive the pusher rods by the actuator 150 to move from the edge of the docking plate 300 towards the center on the docking plate 300. The drone 200 may be pushed by the pusher rods towards the center or default position on the docking plate 300. Assume that the docking plate 300 is quadrilateral, the pusher rods 310 and 320 are disposed on two opposite edges of the docking plate 300, respectively, and the pusher rods 330 and 340 are disposed on the other two opposite edges of the docking plate 300, respectively. The controller 110 may drive the pusher rod 310 to move in a direction D1, drive the pusher rod 320 to move in a direction D2 opposite to the direction D1, drive the pusher rod 330 to move in a direction D3, and drive the pusher rod 340 to move in a direction D4 opposite to the direction D3.

In another aspect, when the drone 200 docked on the docking plate 300 is about to take off or when a flying drone 200 is about to land on the docking plate 300, in order not to interfere with the takeoff or landing of the drone 200, the controller 110 may drive the actuator 150 to drive the pusher rods, which makes the pusher rods to move away from the center or default position on the docking plate 300 (for example, making the pusher rods to move away from the drone 200 docked at the default position). For example, the controller 110 may drive the pusher rod 310 to move in the direction D2, drive the pusher rod 320 to move in the direction D1, drive the pusher rod 330 to move in the direction D4, and drive the pusher rod 340 to move in the direction D3.

The drone docking device 100 may further include a threaded rod 500 driven by the actuator 150. Two ends of the threaded rod 500 may have opposite threads respectively. For example, one end 510 of the threaded rod 500 may have a left-handed thread engaging with a nut 311 of the pusher rod 310, and the other end 520 of the threaded rod 500 may have a right-handed thread engaging with a nut 321 of the pusher rod 320. Accordingly, when the threaded rod 500 rotates, the pusher rods 310 and 320 may be driven by the threaded rod 500 to move in opposite directions.

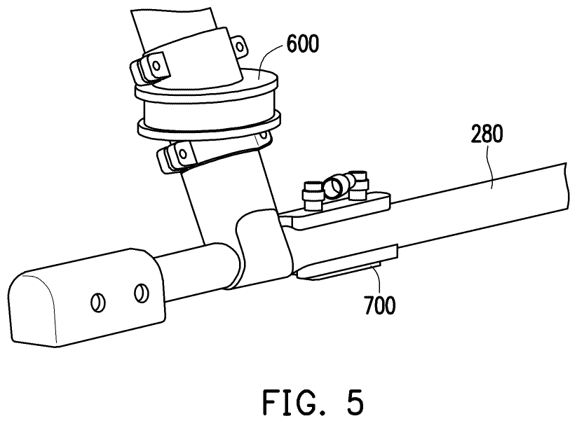

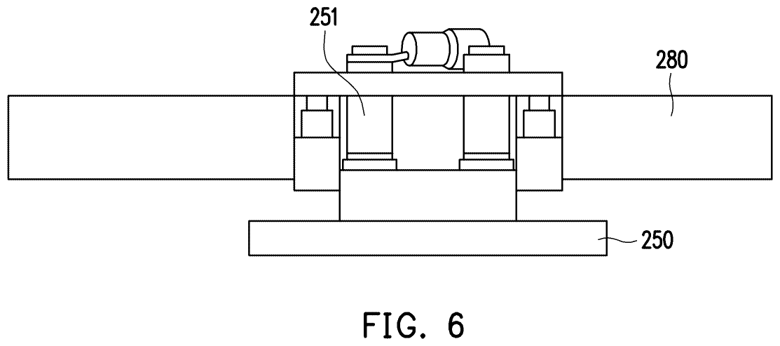

FIG. 5 illustrates a schematic diagram of a pusher rod stopper 600 and a charging mechanism 700 according to an embodiment of the disclosure. FIG. 6 illustrates a schematic diagram of the charging mechanism 700 according to an embodiment of the disclosure. The pusher rod stopper 600 may be disposed on a landing gear 280 of the drone 200. The pusher rods may contact the pusher rod stopper 600 and apply force to the pusher rod stopper 600 to push the drone 200. The charging mechanism 700 of the drone 200 may be disposed on the landing gear 280. The charging mechanism 700 may include a charging terminal 250 and a spring 251. The charging terminal 250 may be fixed to the landing gear 280 by the spring 251. When the drone 200 is landed, the spring 251 may absorb pressure for the charging terminal 250.

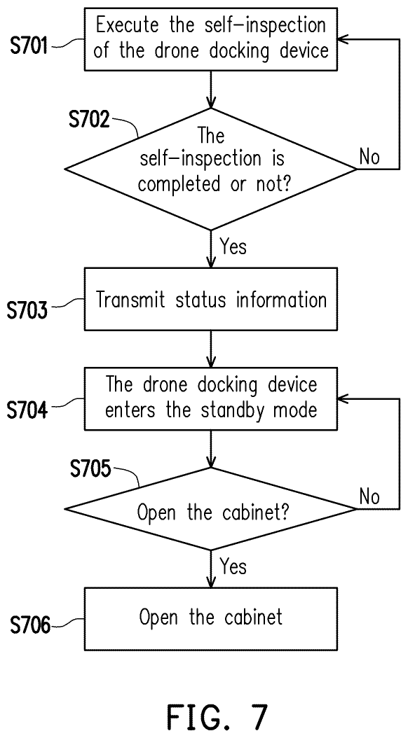

FIG. 7 illustrates a flowchart of opening the cabinet 400 according to an embodiment of the disclosure, where the flowchart may be implemented by the drone system 10 as shown in FIG. 1. The controller 110 may open the cabinet 400 when determining that the drone 200 docked on the docking plate 300 is about to take off or when a flying drone 300 is about to land on the docking plate 300.

In Step S701, the controller 110 may execute self-inspection of the drone docking device 100.

In Step S702, the controller 110 may determine whether the self-inspection is completed. If the self-inspection is completed, Step S703 is executed. If the self-inspection is not completed, the self-inspection continues to be executed.

In Step S703, the controller 110 may transmit status information to the GCS or the drone 200 by the transceiver 130, where the status information may include a result of the self-inspection.

In Step S704, the controller 110 may control the drone docking device 100 to enter a standby mode. In an embodiment, a light indicator coupled to the controller 110 may be disposed on the surface of the cabinet 400. During the standby mode, the controller 110 may activate the green light indicator on the cabinet 400.

In Step S705, the controller 110 may determine whether to open the cabinet 400. For example, the controller 110 may receive a signaling from the GCS or the drone 200 by the transceiver 130, and determine whether to open the cabinet 400 according to the signaling. If the controller 110 determines to open the cabinet 400, Step S706 is executed. If the controller 110 determines not to open the cabinet 400, the controller 110 re-enters the standby mode.

In Step S706, the controller 110 may open the flip lid 410 of the cabinet 400 by the actuator. In an embodiment, during a period when the controller 110 opens the cabinet 400, the controller 110 may activate the warning light indicator on the cabinet 400.

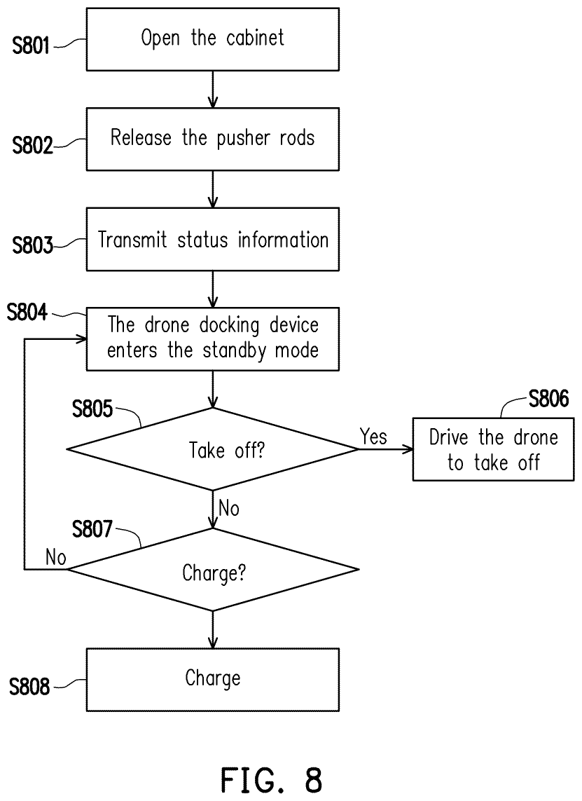

FIG. 8 illustrates a flowchart of takeoff of the drone 200 according to an embodiment of the disclosure, where the flowchart may be implemented by the drone system 10 as shown in FIG. 1.

In Step S801, the controller 110 may open the cabinet 400.

In Step S802, the controller 110 may release the pusher rods (for example: the pusher rods 310, 320, 330, or 340) which are fixed to the drone 200 at the default position on the docking plate 300. In other words, the controller 110 may drive the pusher rods away from the drone 200.

In Step S803, the controller 110 may transmit status information to the GCS or the drone 200 by the transceiver 130, where the status information may indicate that the drone 200 is ready to take off from the docking plate 300.

In Step S804, the controller 110 may control the drone docking device 100 to enter the standby mode.

In Step S805, the controller 210 of the drone 200 may determine whether to take off to execute a task. In an embodiment, the controller 210 may receive a signaling from the GCS or the drone docking device 100 by the transceiver 230, and determine whether to take off or execute the task according to the signaling. If the controller 210 determines that the drone 200 should be taken off, then Step S806 is executed. If the controller 210 determines that the drone 200 should not be taken off, then Step S807 is executed.

In Step S806, the controller 210 may drive the drone 200 to take off by the actuator 240.

In Step S807, the controller 110 may determine whether to charge the drone 200. If the controller 110 determines to charge the drone 200, then Step S808 is executed. If the controller 110 determines not to charge the drone 200, then the controller 110 re-enters the standby mode.

In Step S808, the controller 110 may charge the drone 200 through the charging terminal 140. It should be noted that although in this embodiment the controller 110 charges the drone 200 when the cabinet 400 is in an open state, the disclosure is not limited to thereto. For example, when the drone 200 docked on the docking plate 300 and the cabinet 400 is in a closed state, the controller 110 may also charge the drone 200.

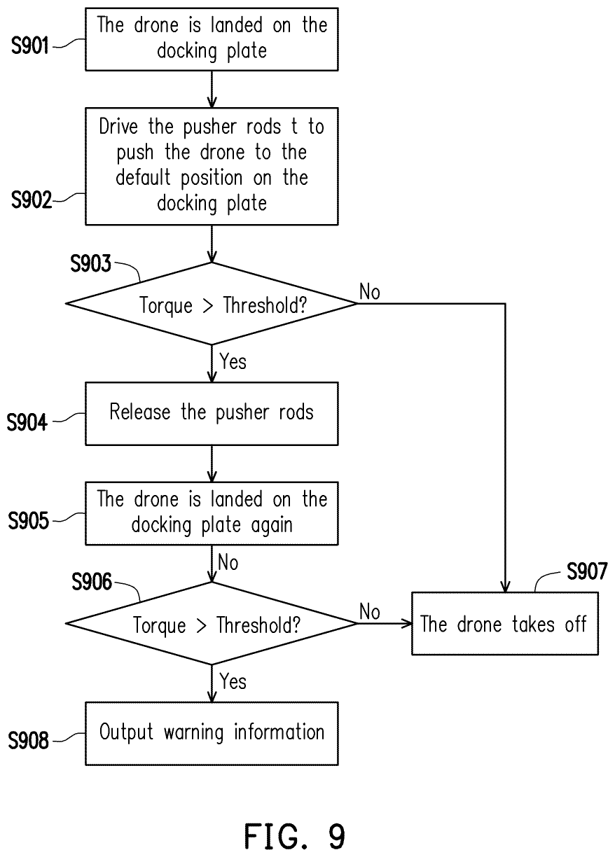

FIG. 9 illustrates a flowchart of landing of the drone 200 according to an embodiment of the disclosure, where the flowchart may be implemented by the drone system 10 as shown in FIG. 1.

In Step S901, the drone 200 may be landed on the docking plate 300. Before the drone 200 is about to land, the controller 110 may release the pusher rods (for example: the pusher rods 310, 320, 330, or 340) to prevent the pusher rods from affecting the landing of the drone 200. In other words, the controller 110 may drive the pusher rods to move away from the center or default position on the docking plate 300.

After the drone 200 completes landing, in Step S902, the controller 110 may drive the pusher rods by the actuator 150 to push the drone 200 to a default position on the docking plate 300. In an embodiment, the torque sensor 160 may be configured to measure the torque of the actuator 150.

In Step S903, the controller 110 may determine whether the torque of the actuator 150 exceeds a threshold. If the torque exceeds the threshold, it indicates that the pusher rods may encounter an obstacle during the process of pushing the drone 200. Accordingly, the controller 110 may execute Step S904. If the torque does not exceed the threshold, then Step S907 is executed.

In Step S904, the controller 110 may release the pusher rods to prevent the pusher rods from affecting the takeoff of the drone 200.

In Step S905, the drone 200 may be taken off from the docking plate 300 and may be landed on the docking plate 300 again.

In Step S906, the controller 110 may again determine whether the torque exceeds the threshold. If the torque exceeds the threshold, Step S908 is executed. If the torque does not exceed the threshold, Step S907 is executed.

In Step S907, the drone 200 may be taken off from the docking plate 300 to execute a task.

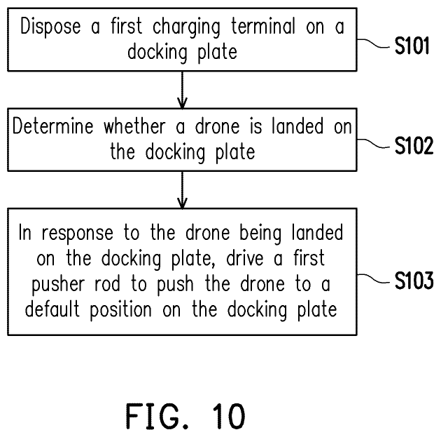

In Step S908, the controller 110 may output warning information by the transceiver 130. For example, the controller 110 may send the warning information to the GCS or the drone 200 FIG. 10 illustrates a flowchart of a method of docking a drone according to an embodiment of the disclosure, where the method may be implemented by the drone system 10 as shown in FIG. 1. In Step S101, a first charging terminal is disposed on the docking plate. In Step S102, whether the drone is landed on the docking plate is determined. In Step S103, in response to the drone being landed on the docking plate, a first pusher rod is driven to push the drone to a default position on the docking plate.

In summary, the drone system of the disclosure may provide a drone docking device with a smaller volume and convenient setup for the drone to charge. When the drone is docked on the docking plate of the drone docking device, the drone docking device may drive the pusher rods to push the drone to the default position, which makes the charging terminals of the drone to align with the charging terminals of the docking plate. The cabinet of the drone docking device has the storage space which may be injected with the cleaning solution. When the drone is docked on the docking plate, the object suspended from the drone may be immersed in the cleaning solution through the opening on the docking plate for cleaning and disinfection.

1. A drone system, comprising:
a drone docking device, comprising:
a docking plate, configured with a first charging terminal;
a first pusher rod;
a first actuator, configured to move the first pusher rod; and
a controller, coupled to the first charging terminal and the first actuator, wherein the controller determines whether a drone is landed on the docking plate, wherein the drone comprises a second charging terminal, and wherein
in response to the drone has landed on the docking plate, the controller drives the first pusher rod by the first actuator to push the drone to a default position on the docking plate, wherein
the default position is a position where the first charging terminal is able to contact to the second charging terminal accurately; and
a cabinet, comprising a flip lid and a second actuator coupled to the controller, wherein the drone docking device is disposed inside the cabinet, wherein
the controller opens the flip lid by the second actuator to expose the docking plate, wherein
the controller closes the flip lid by the second actuator to cover the docking plate, and wherein
a storage space is formed between the docking plate and a bottom of the cabinet, and the docking plate has an opening exposing the storage space.

2. The drone system according to claim 1, wherein the drone docking device further comprises:
a second pusher rod, wherein the first actuator is configured to move the second pusher rod, and wherein
in response to the drone has landed on the docking plate, the controller drives the first pusher rod to move in a first direction and controls the second pusher rod to move in a second direction by the first actuator, wherein the second direction is opposite to the first direction.

3. The drone system according to claim 2, wherein the drone docking device further comprises:
a threaded rod, driven by the first actuator, wherein one end of the threaded rod has a left-handed thread, and the other end of the threaded rod has a right-handed thread, and wherein
the first pusher rod comprises a first nut engaging with the left-handed thread, and the second pusher rod comprises a second nut engaging with the right-handed thread.

4. The drone system according to claim 1, wherein
the controller determines whether the drone on the docking plate is about to take off, wherein
in response to the drone has about to take off, the controller drives the first pusher rod by the first actuator to make the first pusher rod move away from the drone.

5. The drone system according to claim 1,
wherein
after the drone is pushed to the default position, the controller charges the drone through the second charging terminal.

6. The drone system according to claim 5, wherein the second charging terminal is fixed to a landing gear of the drone by a spring.

7-8. (canceled)

9. The drone system according to claim 1, wherein the storage space is injected with a cleaning solution, wherein
when the drone is at the default position, an object suspended on the drone enters the storage space through the opening, and the object is immersed in the cleaning solution.

10. The drone system according to claim 1, further comprising:
the drone, landed at a first position, and landed at a second position after taking off from the first position, wherein
in response to the first position and the second position belonging to different areas, the drone is docked on the drone docking device before proceeding to the second position.

11. The drone system according to claim 1, wherein the drone docking device further comprises:
a torque sensor, coupled to the controller, wherein the torque sensor is configured to measure torque of the first actuator, wherein the controller determines whether the torque is greater than a threshold, and wherein
in response to the torque is greater than the threshold, the controller drives the first pusher rod to move the first pusher rod away from the drone on the docking plate.

12. A method of docking a drone, comprising:
disposing a first charging terminal on a docking plate;
determining whether the drone is landed on the docking plate, wherein
the drone comprises a second charging terminal;
in response to the drone has landed on the docking plate, driving a first pusher rod to push the drone to a default position on the docking plate, wherein
the default position is a position where the first charging terminal is able to contact to the second charging terminal accurately;
disposing a drone docking device inside a cabinet, wherein, the cabinet comprises a flip lid and a second actuator coupled to a controller;
opening the flip lid by the second actuator to expose the docking plate; and
closing the flip lid by the second actuator to cover the docking plate, wherein a storage space is formed between the docking plate and a bottom of the cabinet, and the docking plate has an opening exposing the storage space.
